(19) United States
(12) Patent Application Publication
(10) Pub. No.: US 2021/0257687 A1
(43) Pub. Date: Aug. 19, 2021

(54) DEVICE FOR DISSIPATING HEAT FROM AN ARRANGEMENT OF RECHARGEABLE ELECTROCHEMICAL ENERGY STORES

(71) Applicant: Covestro Intellectual Property GmbH & Co. KG, Leverkusen (DE)

(72) Inventors: Matthias Knaupp, Langenfeld (DE); Thomas Grimm, Köln (DE)

(21) Appl. No.: 16/973,873

(22) PCT Filed: Jun. 19, 2019
(86) PCT No.: PCT/EP2019/066232

§ 371 Date: Dec. 10, 2020

(30) Foreign Application Priority Data
Jun. 29, 2018 (EP) 18180829.6

(51) Int. Cl. H01M 10/617; H01M 10/625; H01M 10/6572; H01M 10/6552; H01M 10/6551; H01M 10/651; H01M 10/653; C08L 69/00

(52) U.S. Cl. CPC H01M 10/617; H01M 10/625; H01M 10/6572; H01M 10/6552; H01M 2220/20; H01M 10/651; H01M 10/653; C08L 69/00; H01M 10/6551

(57) ABSTRACT

The present invention relates to a device for dissipating heat from an arrangement of recharge-able electrochemical energy stores. Said device comprises a heat pipe and a heat coupling-in element. The present invention also relates to an arrangement of rechargeable electrochemical energy stores, which arrangement comprises the device according to the invention.

The present invention relates to a device for dissipating heat from an arrangement of rechargeable electrochemical energy stores. Said device comprises a heat pipe and a heat coupling-in element. The present invention also relates to an arrangement of rechargeable electrochemical energy stores, which arrangement comprises the device according to the invention.

In the context of the present invention, a rechargeable electrochemical energy store is to be understood as meaning a galvanic secondary cell; such a galvanic secondary cell will also be referred to hereinafter as a storage battery, or battery for short. In particular, such a battery is a lithium-ion battery or a sodium/nickel chloride cell, also referred to as a ZEBRA (zero emission battery research activities) battery. An arrangement of two or more batteries, which can be electrically connected to one another, is also referred to as a battery pack. Here, the electrical connection can be realized in series or parallel. In this regard, all the batteries can be connected in series or all the batteries can be connected in parallel. If there is a sufficient number of batteries in a battery pack, it is also possible for subsets of this number of batteries to each be connected in series, while these subsets are then connected in parallel with one another, or it is also possible for subsets of this number of batteries to each be connected in parallel, while these subsets are then connected in series with one another.

The batteries of a battery pack, as is used inter alia for driving electrically driven vehicles, are preferably designed in the form of substantially circular cylindrical bodies whose height is at least as large as the circle diameter of the circular cylinder. It is likewise preferable for all the batteries of a battery pack to be of identical form. In order to save space, that is to say to provide a compact battery pack, in other words a battery pack with a compact design, the batteries of a battery pack are spatially arranged closely adjacent to one another. In this regard, the smallest distance between two batteries in a battery pack is less than 10%, often less than 5%, of the circle diameter of the adjacent cylinder, in particular at most 3 mm, preferably between 1.5 and 0.5 mm, particularly preferably approximately 0.75 mm. Here, the batteries are preferably arranged parallel to one another such that their upper circular surfaces in each case lie in the same plane and their lower circular surfaces in each case lie in the same plane. It is furthermore preferably the case that the batteries in the battery pack are arranged in a manner analogous to the primitive cubic packing, or analogous to the densest hexagonal packing, of spheres.

The electrodes of a battery are in this case normally arranged such that one electrode, generally the anode, is situated on one of the circular surfaces of the battery and on a sub-region of the casing surface of the battery, which sub-region is directly adjacent to this circular surface, wherein here, the current can be drawn off for example by way of a welded-on wire, also often referred to as a pin. The other, oppositely charged electrode, generally the cathode, is then situated on the remaining region of the casing surface of the battery, wherein the current can be drawn off there for example by way of a welded-on wire. Here, the two oppositely charged electrodes are suitably electrically insulated with respect to one another. In the height direction of the casing, the extent of the electrode which is situated on the remaining region of the casing surface assumes at least 50%, preferably at least 60%, particularly preferably at least 70%, of the height of the casing surface. Preferably, all the batteries of a battery pack have the same polarity and same orientation of their electrodes.

In order that the batteries of a battery pack remain in the desired arrangement with respect to one another, these are generally arranged in a cell holder.

When charging a battery, electrical energy is converted into chemical energy, and when discharging a battery, that is to say when drawing off current, chemical energy is converted into electrical energy. It should be noted that, in the context of the present invention, the term “current” always refers to the electrical current, unless stated otherwise.

With all conversions from one form of energy into another, energy losses occur. This energy loss generally becomes noticeable through the radiation of heat, which in turn manifests itself in a rise in temperature. The quicker said energy conversion is realized, and the poorer the generated heat is able to be removed, the greater said rise in temperature.

In the case of a battery pack, a large amount of heat is generated in particular if the batteries of the battery pack are charged in a very short time or a large amount of electrical energy is released in a very short time. Here, the term “in a very short time” is to be understood as meaning that the charging or discharging current of a battery is at least twice as large as the current with which said battery is intended to be charged during regulated operation. Owing to the compact design of a battery pack, the generated heat is removed only poorly. Neither the natural capability, inherent in the battery pack, for convection nor the natural capability, inherent in the battery pack, for heat conduction are sufficient for this purpose. The rise in temperature occurring due to the poor removal of heat leads to damage to the batteries, which damage can lead to the reduction in the power, to the reduction in the lifetime, up to the failure, of one or more of the batteries.

In particular, temperatures of 60° C. and above are harmful here. Also harmful are temperature differences of 4K and more within a battery pack for batteries, in particular for lithium-ion batteries.

Moreover, it is generally the case that a battery pack is situated in a housing, on the one hand to protect the battery pack against external influences, for example weather influences or mechanical loads, and on the other hand, for example, to protect persons against contact with the electrodes and thus the risk of electric shock. Said housing makes it even more difficult for the generated heat to be removed, since it hinders convection and heat conduction.

Forced convection of the battery pack, for example by forced aeration, in particular by way of a fan, has been found to be inexpedient since this in turn more than negates the advantage of the compact design of the battery pack.

These limitations for the removal of heat from the battery pack hinder the use of such battery packs in cars which are completely or partially current-driven. Such cars which are completely or partially current-driven will also be referred to hereinafter as electric cars. The successful introduction of electric cars necessitates the provision of high-efficiency battery packs which allow the electric cars a range and charging speed which at least largely correspond to the range and fuelling speed of corresponding cars which are driven exclusively by an internal combustion engine. For the range of an electric car, this means that it equates to at least 30%, preferably to at least 40%, particularly preferably to at least 50%, of the range of corresponding cars which are driven exclusively by an internal combustion engine. For the charging speed of the battery pack of an electric car, this means that it equates to at most 30 minutes, preferably to at most 20 minutes, particularly preferably to at most 15 minutes.

Here, it should be stated that, in relation to the engine power of corresponding cars which are driven exclusively by an internal combustion engine, electric cars are already at least evenly matched today.

Forced convection of the battery pack, for example by forced aeration, in particular by way of a fan, has been found to be inexpedient since this in turn more than negates the advantage of the compact design of the battery pack. It has also been found that, in the case of such forced convection, the incoming air is swirled in the intermediate spaces between the individual batteries and therefore no flow channels are able to be formed but rather, by contrast, a back pressure counter to the further air supply is formed. This further hinders the cooling of the battery pack.

The problem of the occurrence of swirling of the incoming air in the intermediate spaces between the individual batteries and the occurrence of the above-mentioned consequences resulting therefrom also arises if it is intended for a battery pack which is installed in an electric car to be cooled by relative wind. Such direct cooling of a battery pack by relative wind is to be understood as forced convection.

As a solution to the problem, WO2010060856A1 proposes the provision of a freely flowing temperature control liquid between the batteries of a battery pack in order to control the temperature of a battery pack. A heat pipe is then introduced into such a temperature control liquid in order to dissipate outwardly the heat generated in the battery pack. However, this solution has the disadvantage that the temperature control liquid can escape and cause damage if an electric car which has a battery pack provided with such a temperature control liquid is involved in an accident. Also, in the case of such an arrangement, it is difficult for example to replace a battery pack having discharged batteries with a battery pack having charged batteries because, firstly, such a battery pack is relatively heavy, and secondly, it is possible for the temperature control liquid to escape in the event of leaks.

As a solution to the problem, WO2017182156A1 proposes the provision of thermal pads, for example composed of silicone or acrylic, for transferring heat from a battery or multiple batteries of a battery pack to a heat pipe and then transferring said heat from said heat pipe to a housing cover and from there to the surroundings. Although this solution prevents the possibility of a temperature control liquid escaping and causing damage if a car which has a battery pack provided with such a temperature control liquid is involved in an accident, since no such temperature control liquid is present, firstly, the thermal conductivities of the materials, proposed in WO2017182156A1, for the thermal pads are very low, which results in low effectiveness of the transfer of heat to or from the heat pipe, and secondly, the spatial arrangement proposed in WO2017182156A1 of the thermal pads relative to the heat pipe has low suitability for effective transfer of heat to or from the heat pipe.

It is therefore an object of the present invention to provide a device which overcomes the disadvantages of the prior art.

In particular, it is an object of the present invention to provide a device which makes it possible not only for heat to be removed from a battery pack more quickly, but also for excessively large temperature differences within the battery pack to be prevented, than is possible through the combination of the natural capability, inherent in the battery pack, for convection and the natural capability, inherent in the battery pack, for heat conduction.

Here, it is preferably intended to be able to dispense with forced convection, in particular forced convection by way of a fan.

Moreover, it is intended to dispense with a temperature control liquid. This is to avoid the possibility of temperature control liquid escaping and causing damage if an electric car which has a battery pack provided with such a temperature control liquid is involved in an accident. It also intended to be the case that it is easily possible to replace such a battery pack with another one, for example a battery pack having discharged batteries with a battery pack having charged batteries, without heavy lifting being necessary or it being possible for temperature control liquid to escape due to leaks.

It is intended to ensure in particular that the batteries of a battery pack cannot be heated to a temperature of 60° C. or above by way of charging or discharging of the batteries.

In this way, damage to the batteries, which can lead to the reduction in the power, to the reduction in the lifetime, up to the failure, of one or more of the batteries, is intended to be prevented.

This is to enable the provision of high-efficiency battery packs, which allow electric cars a range and charging speed which at least largely correspond to the range and fuelling speed of corresponding cars which are driven exclusively by an internal combustion engine.

Said object is achieved by a device having the features of the main claim. Preferred configurations are to be found in the dependent claims.

Said object is achieved in particular by a heat dissipation insert, also referred to hereinafter as insert for short.

Said insert comprises a heat pipe and a heat coupling-in element. The heat pipe of an insert will also be referred to hereinafter as an insert heat pipe.

The insert is intended to be suitable for being arranged in the neighbourhood intermediate space between two or more batteries of a battery pack.

The neighbourhood intermediate space of these two or more batteries is formed by two batteries in an arrangement of the batteries in series, while in an arrangement of the batteries analogous to the primitive cubic packing of spheres, this neighbourhood intermediate space is formed by four batteries, and in an arrangement of the batteries analogous to the densest hexagonal packing of spheres, this neighbourhood intermediate space is formed by three batteries.

A heat coupling-in element is a physical object, in particular a shaped body, which is able to transfer heat from a heat source to a heat pipe, in particular to introduce heat into a heat pipe.

Heat pipes are known in principle to a person skilled in the art. A heat pipe is a heat transfer means which, utilizing evaporation heat of a working medium, permits a high heat flux density, that is to say large quantities of heat are able to be transported at a small cross-sectional area. Although heat pipes can be used only in a limited temperature range, for example in the range from 0 to 250° C. for heat pipes composed of copper, with water as the working medium, they have in said range a thermal resistance which is considerably lower than that of metals. The behaviour of the heat pipes is consequently very similar to the isothermal change of state. An approximately constant temperature prevails over the length of the heat pipe. For the same transfer capacity, therefore, considerably lighter designs than conventional heat transfer means are possible under the same conditions of use. Heat pipes comprise a hermetically encapsulated volume in the shape of a pipe, with in each case one end facing the heat source and one end facing the heat sink. The pipe is filled with a working medium, for example water or ammonia, a small part of which occupies the volume in the liquid state and a relatively large part of which occupies the volume in the vapour state. When heat is introduced, the working medium begins to evaporate, specifically at the end facing the heat source. In this way, the pressure is increased locally above the liquid surface in the vapour space, which leads to a small pressure gradient within the heat pipe. The vapour which is generated thus flows to a position with a lower temperature, that is to say to the end facing the heat sink, where it condenses. At said position, the temperature is increased by the condensation heat being released. The previously absorbed latent heat is released to the surroundings. By way of capillary forces, the then liquid working medium returns again to the position at which the heat is introduced. (Source: Wikipedia.)

For the sake of clarity, it should be noted that, in the context of the present invention, the working medium of a heat pipe does not constitute a temperature control liquid flowing freely between the batteries of a battery pack, as is mentioned in this document in the discussion of the technical solution disclosed in WO2010060856A1.

The insert according to the invention makes it possible not only for the batteries of a battery pack not to be heated to a temperature of 60° C. or above by way of charging or discharging of the batteries, but also for temperature differences of 4K or more not to occur within a battery pack.

In this way, damage to the batteries, which can lead to the reduction in the power, to the reduction in the lifetime, up to the failure, of one or more of the batteries, can be prevented.

Moreover, a temperature control liquid can be dispensed with. This avoids the possibility of a temperature control liquid escaping and causing damage if an electric car which has a battery pack provided with such a temperature control liquid is involved in an accident. It is also the case that it is easily possible to replace such a battery pack with another one, for example a battery pack having discharged batteries with a battery pack having charged batteries, since such a battery pack is easier to handle and generally lighter, at least not heavier, than one with temperature control liquid and it is not possible for temperature control liquid to escape due to leaks.

This, moreover, achieves the object of providing high-efficiency battery packs which allow the electric cars a range and charging speed which at least largely correspond to the range and fuelling speed of corresponding cars which are driven exclusively by an internal combustion engine.

Preferably, the heat coupling-in element of the insert according to the invention consists substantially of a thermally conductive material having an in-plane thermal conductivity of at least 0.1 W/(m*K), preferably of at least 0.2 W/(m*K), particularly preferably of at least 0.5 W/(m*K), very particularly preferably of at least 1 W/(m*K), in particular preferably of at least 2 W/(m*K).

Particularly preferably, the heat coupling-in element of the insert according to the invention consists substantially of a thermally conductive, electrically insulating thermoplastic composition having an in-plane thermal conductivity of 0.1 to 30 W/(m*K), preferably of 0.2 to 10 W/(m*K), particularly preferably of 0.5 to 4 W/(m*K) or of 1 to 10 W/(m*K), very particularly preferably of 2 to 7 W/(m*K). Here, said thermally conductive, electrically insulating thermoplastic composition has a volume resistivity of more than 10¹⁰ ohm*m, preferably of more than 10¹² ohm*m, particularly preferably of more than 10¹³ ohm*m.

Electrical insulation is defined hereinafter as a volume resistivity of more than 10¹⁰ ohm*m, preferably of more than 10¹² ohm*m, particularly preferably of more than 10¹³ ohm*m.

Here, the volume resistivity is determined in accordance with DIN IEC 60093 (DIN IEC 60093:1993-12).

If in the context of the present invention reference is made to thermal conductivity in the injection moulding direction (in-plane thermal conductivity), said thermal conductivity was determined at 23° C. in accordance with ASTM E 1461 (ASTM E 1461:2013) on samples of dimensions 80 mm×80 mm×2 mm.

If in the present document reference is made to the term “substantially” in the context in which a first physical object consists substantially of a second physical object, this means that said first physical object consists to an extent of at least 50% by weight, preferably to an extent of at least 65% by weight, particularly preferably to an extent of at least 80% by weight, very particularly preferably to an extent of at least 95% by weight, of the second physical object. In relation to the heat coupling-in element of the insert according to the invention, this means that the heat coupling-in element consists to an extent of at least 50% by weight, preferably to an extent of at least 65% by weight, particularly preferably to an extent of at least 80% by weight, very particularly preferably to an extent of at least 95% by weight, of a thermally conductive, electrically insulating thermoplastic composition having an in-plane thermal conductivity of 0.1 to 30 W/(m*K), preferably of 0.2 to 10 W/(m*K), particularly preferably of 0.5 to 4 W/(m*K) or of 1 to 10 W/(m*K), very particularly preferably of 2 to 7 W/(m*K), and having a volume resistivity of more than 10¹⁰ ohm*m, preferably of more than 10¹² ohm*m, particularly preferably of more than 10¹³ ohm*m.

In a preferred alternative 1, the heat coupling-in element of the insert according to the invention consists substantially of a thermally conductive thermoplastic composition having an inplane thermal conductivity of 0.5 to 50 W/(m*K), preferably of 1 to 30 W/(m*K), particularly preferably of 2 to 20 W/(m*K), in particular of 7 to 15 W/(m*K). In this case, the thermally conductive thermoplastic composition may have a volume resistivity of 10¹⁰ ohm*m or less.

In a preferred alternative 2, the heat coupling-in element of the insert according to the invention consists substantially of a metal, in particular aluminium, copper or iron, or of a metal alloy, in particular an aluminium alloy, a copper alloy or an iron alloy.

If alternative 1 is selected and if the thermally conductive thermoplastic composition has a volume resistivity of 10¹⁰ ohm*m or less, or if alternative 2 is selected, it is necessary for the battery, or the batteries, of the battery pack, which, in the region of at least one of its/their electrodes, comes/come into contact with the heat coupling-in element, to have electrical insulation with respect to the heat coupling-in element. Said electrical insulation may be realized for example by an envelopment or coating with a material having a volume resistivity of more than 10¹⁰ ohm*m, preferably of more than 10¹² ohm*m, particularly preferably of more than 10¹³ ohm*m.

In this way, it is can then be ensured that neither an electrical short circuit occurs nor a battery is unnecessarily discharged.

Preferably, the insert heat pipe is at least partially surrounded by, particularly preferably encapsulated with, the thermally conductive thermoplastic composition of the heat coupling-in element As a result of the encapsulation, it is achieved that the insert heat pipe is connected to the thermally conductive thermoplastic composition of the heat coupling-in element such that effective heat transfer is possible since, due to the encapsulation, a materially bonded connection is formed at least in parts of the contact surfaces between the insert heat pipe and the thermally conductive thermoplastic composition of the heat coupling-in element. This in turn has the effect that, between the insert heat pipe and the thermally conductive thermoplastic composition of the heat coupling-in element, there is no longer an intermediate space which hinders effective heat transfer.

Particularly preferably, the ratio of outer diameter to wall thickness of the insert heat pipe is from 10:1 to 4:1, preferably 8:1 to 4:1, particularly preferably 7:1 to 5:1. This ensures that, during encapsulation, the insert heat pipe is neither collapsed nor burst, nor damaged in some other way to such an extent that effective heat dissipation is hindered. This ensures that, following the encapsulation, the capability of the insert heat pipe for heat dissipation is at least 80%, preferably at least 90%, particularly preferably at least 95%, in particular at least 98%, of the capability for heat dissipation of the non-encapsulated heat pipe, that is to say the heat pipe prior to the encapsulation.

Preferably, the insert heat pipe is longer than the longest of the two or more batteries, particularly preferably the insert heat pipe is longer than the longest of the two or more batteries by at least 10%, very particularly preferably the insert heat pipe is longer than the longest of the two or more batteries by at least 20%.

Preferably, the insert is shaped such that it is suitable for occupying the neighbourhood intermediate space between two or more directly adjacent batteries of a battery pack as fully as possible, that is to say to an extent of at least 65%, preferably to an extent of at least 80%, particularly preferably to an extent of at least 90%, very particularly preferably to an extent of at least 95%.

Preferably, the length of the heat coupling-in element corresponds here to at least 65%, preferably to at least 80%, particularly preferably to at least 90%, very particularly preferably to at least 100%, in particular more than 100%, of the length of the shortest of the at least two batteries.

Preferably, the insert heat pipe is introduced along the length of the heat coupling-in element to an extent of at least 80%, preferably to an extent of at least 90%, particularly preferably to an extent of 95 to 99%, in each case in relation to the length of the heat coupling-in element.

According to the arrangement of the batteries in the battery pack, in an arrangement of the batteries in series, the cross section of the insert is a surface delimited by two mutually parallel lines of equal length which are exactly opposite one another, and by two circular arcs of equal size, wherein the in each case directly adjacent line ends of the in each case opposite lines are connected to one another by in each case one of the circular arcs, wherein both circular arcs are arranged in a concave manner.

According to the arrangement of the batteries in the battery pack analogous to the primitive cubic packing of spheres, the cross section of the insert is a surface delimited by four lines of equal length which are each offset by 90° from one another, and by four circular arcs of equal size, wherein the in each case directly adjacent line ends of the lines in each case offset by 90° with respect to one another are connected to one another by in each case one of the circular arcs, wherein all the circular arcs are concave.

According to the arrangement of the batteries in the battery pack analogous to the densest hexagonal packing of spheres, the cross section of the insert is a surface delimited by three lines of equal length which are each offset by 120° from one another, and by three circular arcs of equal size, wherein the in each case directly adjacent line ends of the lines in each case offset by 120° with respect to one another are connected to one another by in each case one of the circular arcs, wherein all the circular arcs are concave.

In other arrangements of the batteries in the battery pack, the cross section of the insert is formed in a manner analogous to the aforementioned examples for the cross section.

Preferably, the insert also has a heat coupling-out element. A heat coupling-out element is a physical object, in particular a shaped body, which is able to dissipate heat from a heat pipe. A heat coupling-out element thus constitutes a heat sink.

Preferably, at its end facing away from the heat source, that is to say the end which faces away from the two or more batteries, the insert heat pipe has a heat coupling-out element as a heat sink. The insert heat pipe is connected to said heat sink, for example by insertion with accurate fit of that end of the insert heat pipe facing away from the heat source into a bore of the heat sink, or if the heat sink consists substantially of a thermoplastic composition by encapsulation with the thermoplastic composition of the heat sink of that end of the insert heat pipe facing away from the heat source, such that the heat can be effectively transferred from the insert heat pipe to the heat sink. From the heat sink, the heat is then released to the surroundings by convection and heat conduction, in particular by convection. The heat sink may be designed for example in the form of a cooling plate or ribbed body or in some other suitable manner. This heat sink will also be referred to hereinafter as a battery pack heat sink. The battery pack heat sink is generally situated outside the cell holder and within the housing surrounding the battery pack. However, the battery pack heat sink may also be situated outside the housing.

Said battery pack heat sink preferably consists substantially of a thermally conductive thermoplastic composition having an in-plane thermal conductivity of 0.5 to 50 W/(m*K), preferably of 1 to 30 W/(m*K), particularly preferably of 2 to 20 W/(m*K), in particular of 7 to 15 W/(m*K). In this case, this thermally conductive thermoplastic composition may have a volume resistivity of 10¹⁰ ohm*m or less.

As an alternative, said battery pack heat sink preferably consists substantially of a metal, in particular aluminium, copper or iron, or of a metal alloy, in particular an aluminium alloy, a copper alloy or an iron alloy.

As a further alternative, that end of an insert heat pipe facing away from the heat source preferably ends freely, in particular outside the cell holder, more particularly outside the housing surrounding the battery pack, that is to say is for example surrounded only by air. Owing to the spatially less confined conditions and the consequently better convection, the insert is able to effectively remove heat in this way.

The above-described embodiments of the insert according to the invention thus make it possible for the batteries of a battery pack not to be heated to a temperature of 60° C. or above by way of charging or discharging of the batteries.

In this way, damage to the batteries, which can lead to the reduction in the power, to the reduction in the lifetime, up to the failure, of one or more of the batteries, can be prevented.

Moreover, a temperature control liquid can be dispensed with. This avoids the possibility of a temperature control liquid escaping and causing damage if an electric car which has a battery pack provided with such a temperature control liquid is involved in an accident. It is also the case that it is easily possible to replace such a battery pack with another one, for example a battery pack having discharged batteries with a battery pack having charged batteries, since such a battery pack is easier to handle and generally lighter, at least not heavier, than one with temperature control liquid and it is not possible for temperature control liquid to escape due to leaks.

This, moreover, achieves the object of providing high-efficiency battery packs which allow the electric cars a range and charging speed which at least largely correspond to the range and fuelling speed of corresponding cars which are driven exclusively by an internal combustion engine.

In particular, the insert according to the invention makes it possible for the batteries of a battery pack not to be heated to a temperature of 60° C. or above by way of charging or discharging of the batteries if an insert according to the invention is introduced into 50% or more, preferably into 70% or more, particularly preferably into 90% or more, very particularly preferably into 95% or more, of the neighbourhood intermediate spaces between the batteries of a battery pack.

The present invention therefore also relates to a battery pack in which an insert according to the invention is introduced into 50% or more, preferably into 70% or more, particularly preferably 90% or more, very particularly preferably into 95% or more, in particular into 100%, of the neighbourhood intermediate spaces between the batteries of a battery pack.

In a preferred embodiment of this invention, if a battery pack heat sink is present, this is connected to at least two insert heat pipes. This battery pack heat sink thus constitutes a common heat sink for these at least two insert heat pipes. It is preferably the case that 50% or more, preferably 70% or more, particularly preferably 90% or more, very particularly preferably 95% or more, of the insert heat pipes of a battery pack are connected to the same battery pack heat sink serving as a heat sink.

As an alternative, the insert heat pipes of a battery pack may preferably be connected to multiple different battery pack heat sinks, wherein an insert heat pipe is always connected to one battery pack heat sink only, but a battery pack heat sink is connected to at least one insert heat pipe, preferably to two or more insert heat pipes.

In one particular embodiment of the invention, regardless of whether a battery pack heat sink is connected to one insert heat pipe or multiple insert heat pipes, a battery pack heat sink is connected to at least one further heat pipe, wherein this battery pack heat sink constitutes a heat source for this at least one further heat pipe. This at least one further heat pipe will also be referred to hereinafter as a battery pack heat sink heat pipe. The battery pack heat sink and battery pack heat sink heat pipe are connected to one another, for example by insertion with accurate fit of that end of the battery pack heat sink heat pipe facing the battery pack heat sink into a bore of the heat sink, or if the heat sink consists substantially of a thermoplastic composition by encapsulation with the thermoplastic composition of the heat sink of that end of the battery pack heat sink heat pipe facing the battery pack heat sink, such that the heat can be effectively transferred from the battery pack heat sink to the battery pack heat sink heat pipe and thus the heat can be effectively introduced into the battery pack heat sink heat pipe.

Preferably, that end of the at least one battery pack heat sink heat pipe facing away from the battery pack heat sink is connected to an electrothermal transducer, preferably to a Peltier element or to a thermal element, particularly preferably to a Peltier element. Said electrothermal transducer serves said at least one battery pack heat sink heat pipe as a heat sink and converts into electrical current the heat transferred from the at least one battery pack heat sink heat pipe to the electrothermal transducer. This current can be used for a wide variety of applications, for example for the heating or the cooling of air streams by way of which the temperature of the passenger interior compartment is controlled.

Preferably in each case one battery pack heat sink heat pipe is connected to in each case one electrothermal transducer.

Peltier elements or thermal elements are known in principle to a person skilled in the art.

A Peltier element is an electrothermal transducer which, based on the Peltier effect, generates a temperature difference in the case of a passage of current, or which generates a passage of current in the case of a temperature difference (Seebeck effect). Peltier elements may be used both for cooling and when the current direction is reversed for heating. (Source: Wikipedia.)

A Peltier element has a so-called “hot end” and a so-called “cold end”. The hot end is that location on a Peltier element at which heat is introduced into the Peltier element; the cold end is that location on a Peltier element at which current can be drawn off from the Peltier element.

A thermal element is a pair of metallic conductors composed of different material, which are connected at one end. According to the Seebeck effect, in a circuit composed of two different electrical conductors, an electrical voltage is generated in the case of a temperature difference between the contact points. According to Ohm's law, a flow of current can be obtained by way of external circuitry. Multiple thermal elements connected in series form a thermopile, which provides an electrical voltage which is higher by the number thereof (Source: Wikipedia.)

In the preferred case in which the electrothermal transducer is a Peltier element, the at least one battery pack heat sink heat pipe is connected to the hot end of the Peltier element, for example in a force-fitting manner via a screw or bracket connection, wherein preferably, a thermally conductive paste is introduced between that end of the at least one battery pack heat sink heat pipe facing away from the battery pack heat sink and the Peltier element. In this way, it is possible to ensure that effective heat transfer from the battery pack heat sink heat pipe to the Peltier element is realized.

Since the surface of the at least one battery pack heat sink heat pipe, which transfers heat to the hot end of the Peltier element, is smaller than the surface of the hot end of the Peltier element, it is preferably the case that the hot end of the Peltier element is provided with a thermally conductive layer composed of copper, silver or gold or of a copper, silver or gold alloy in order to ensure a better transfer of heat from the at least one battery pack heat sink heat pipe to the hot end of the Peltier element. Said heat conductive layer may for example be in the form of a film or applied by vapour deposition.

In order to prevent the at least one battery pack heat sink heat pipe from transferring more heat to the hot end of the Peltier element than is able to flow from said hot end of the Peltier element, and thus an excess of heat at the hot end of the Peltier element from occurring, a further heat sink is situated at that end of the at least one battery pack heat sink heat pipe facing the Peltier element. Said heat sink will also be referred to hereinafter as a hot-end heat sink. The hot-end heat sink can thus prevent the occurrence of overheating, in particular local overheating, at the hot end of the Peltier element, as a result of which components of the Peltier element can be damaged. The hot-end heat sink generally releases the excess heat to the surroundings.

The hot end of the Peltier element and the hot-end heat sink are connected to one another such that the heat can be effectively transferred from the hot end of the Peltier element to the hot-end heat sink. This connection may for example be formed in an analogous manner to the one described above between the battery pack heat sink heat pipe and the hot end of the Peltier element.

The hot-end heat sink preferably consists substantially of a thermally conductive thermoplastic composition having an in-plane thermal conductivity of 0.5 to 50 W/(m*K), preferably of 1 to 30 W/(m*K), particularly preferably of 2 to 20 W/(m*K), in particular of 7 to 15 W/(m*K). In this case, this thermally conductive thermoplastic composition may have a volume resistivity of 10¹⁰ ohm*m or less.

As an alternative, said hot-end heat sink preferably consists substantially of a metal, in particular aluminium, copper or iron, or of a metal alloy, in particular an aluminium alloy, a copper alloy or an iron alloy.

The hot-end heat sink and the at least one battery pack heat sink heat pipe are connected to one another such that the heat can be effectively transferred from the at least one battery pack heat sink heat pipe to the hot-end heat sink, for example by insertion with accurate fit of that end of the battery pack heat sink heat pipe facing the hot-end heat sink into a bore of the hot-end heat sink, or if the hot-end heat sink consists substantially of a thermoplastic composition by encapsulation with the thermoplastic composition of the hot-end heat sink of that end of the battery pack heat sink heat pipe facing the hot-end heat sink.

As already mentioned further above, in order for it to be possible for a Peltier element to convert heat into an electrical current, a temperature difference between the hot end of the Peltier element and the cold end of the Peltier element is necessary. In order to ensure this, there is also preferably arranged a heat sink at the cold end of the Peltier element. Said heat sink will also be referred to hereinafter as a cold-end heat sink.

The cold-end heat sink preferably consists substantially of a thermally conductive thermoplastic composition having an in-plane thermal conductivity of 0.5 to 50 W/(m*K), preferably of 1 to 30 W/(m*K), particularly preferably of 2 to 20 W/(m*K), in particular of 7 to 15 W/(m*K). In this case, the thermally conductive thermoplastic composition may have a volume resistivity of 10¹⁰ ohm*m or less.

As an alternative, said cold-end heat sink preferably consists substantially of a metal, in particular aluminium, copper or iron, or of a metal alloy, in particular an aluminium alloy, a copper alloy or an iron alloy.

The cold end of the Peltier element and the cold-end heat sink are connected to one another such that the heat can be effectively transferred from the cold end of the Peltier element to the cold-end heat sink. This connection too may for example be formed in an analogous manner to the one described above between the battery pack heat sink heat pipe and the hot end of the Peltier element.

In an alternative embodiment of the invention, no battery pack heat sink is provided and no battery pack heat sink heat pipe is provided. Instead, each individual one of the insert heat pipes is connected to a thermoelectric transducer.

Applying in a corresponding manner to said electrothermal transducer and to the connection of the insert heat pipe to the electrothermal transducer are the preferred embodiments described above for an electrothermal transducer, a battery pack heat sink heat pipe and the connection of an electrothermal transducer to a battery pack heat sink heat pipe.

The above-described embodiments of the insert make it possible in a special manner not only for the batteries of a battery pack not to be heated to a temperature of 60° C. or above by way of charging or discharging of the batteries, but also for temperature differences of 4K or more not to occur within a battery pack.

Thus, damage to the batteries, which can lead to the reduction in the power, to the reduction in the lifetime, up to the failure, of one or more of the batteries, can be prevented in a special manner.

Moreover, a temperature control liquid can be dispensed with. This avoids the possibility of a temperature control liquid escaping and causing damage if an electric car which has a battery pack provided with such a temperature control liquid is involved in an accident. It is also the case that it is easily possible to replace such a battery pack with another one, for example a battery pack having discharged batteries with a battery pack having charged batteries, since such a battery pack is easier to handle and generally lighter, at least not heavier, than one with temperature control liquid and it is not possible for temperature control liquid to escape due to leaks.

This, moreover, achieves the object of providing high-efficiency battery packs which allow electric cars a range and charging speed which at least largely correspond to the range and fuelling speed of corresponding cars which are driven exclusively by an internal combustion engine.

The present invention therefore also relates to an electric car having at least one insert according to the invention or a battery pack according to the invention.

Suitable thermoplastics for the thermoplastic compositions used according to the invention are polycarbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates and polyor copolymethacrylate, such as for example poly- or copolymethylmethacrylates (such as PMMA), polyamides (preferably polyamide 6 (PA6) and polyamide 6.6 (PA6.6)), and copolymers with styrene, such as for example transparent polystyrene-acrylonitrile (PSAN), thermoplastic polyurethanes, polymers based on cyclic olefins (for example TOPAS CD, a commercial product from Ticona), or mixtures of the polymers mentioned, and polycarbonate blends with olefinic copolymers or graft polymers, such as for example styrene/acrylonitirle copolymers, and possibly further ones of the aforementioned polymers. This applies regardless of whether a thermoplastic composition used according to the invention has a volume resistivity of 10¹⁰ ohm*m or less, or has a volume resistivity of more than 10¹⁰ ohm*m, preferably of more than 10¹² ohm*m, particularly preferably of more than 10¹³ ohm*m.

A suitable thermoplastic the for thermoplastic compositions used according to the invention is in particular polycarbonate.

According to the invention, the thermally conductive thermoplastic composition can it if has a volume resistivity of 10¹⁰ ohm*m or less preferably be selected from those described in WO 2015/135958 A1.

Other thermally conductive thermoplastic compositions which are likewise usable for the present invention are disclosed for example in WO2012/174574A2, WO2017/005735A1, WO2017/005738A1 and WO2017005736A1, wherein the thermally conductive thermoplastic compositions disclosed in WO2017/005735A1 and used according to the invention are particularly suitable.

According to the invention, the thermally conductive thermoplastic composition can if it is to have a volume resistivity of more than 10¹⁰ ohm*m, preferably of more than 10¹² ohm*m, particularly preferably of more than 10¹³ ohm*m preferably be selected from those described in WO 2017/005736 A1 or from those described in WO 2017/005735 A1.

Alternatively, according to the invention, the thermally conductive thermoplastic composition can if it is to have a volume resistivity of more than 10¹⁰ ohm*m, preferably of more than 10¹² ohm*m, particularly preferably of more than 10¹³ ohm*m also preferably be selected from those described in WO 2017/005738 A1.

The present invention therefore relates to the use of a thermoplastic composition having an inplane thermal conductivity of at least 0.1 W/(m*K), preferably of at least 0.2 W/(m*K), particularly preferably of at least 0.5 W/(m*K), very particularly preferably of at least 1 W/(m*K), in particular preferably of at least 2 W/(m*K), for the dissipation of heat from a battery pack.

According to the invention, the thermoplastic composition preferably has a volume resistivity of more than 10¹⁰ ohm*m, preferably of more than 10¹² ohm*m, particularly preferably of more than 10¹³ ohm*m.

Preferred configurations of the invention are illustrated in the figures below, without the invention being limited in this way to these configurations.

The following designations are used:

1 Battery

2 Insert heat pipe

3 Battery pack

4 Heat coupling-in element

5 Insert

6 Neighbourhood intermediate space for two batteries in series

7 Neighbourhood intermediate space between three batteries for an arrangement of the batteries analogous to the densest hexagonal packing of spheres

8 Neighbourhood intermediate space for an arrangement of four batteries analogous to the primitive cubic packing of spheres

9 Battery pack heat sink

10 Battery pack heat sink heat pipe

11 Cell holder

12 Housing

13 Hot-end heat sink

14 Heat conduction layer

15 Peltier element

16 Cold-end heat sink

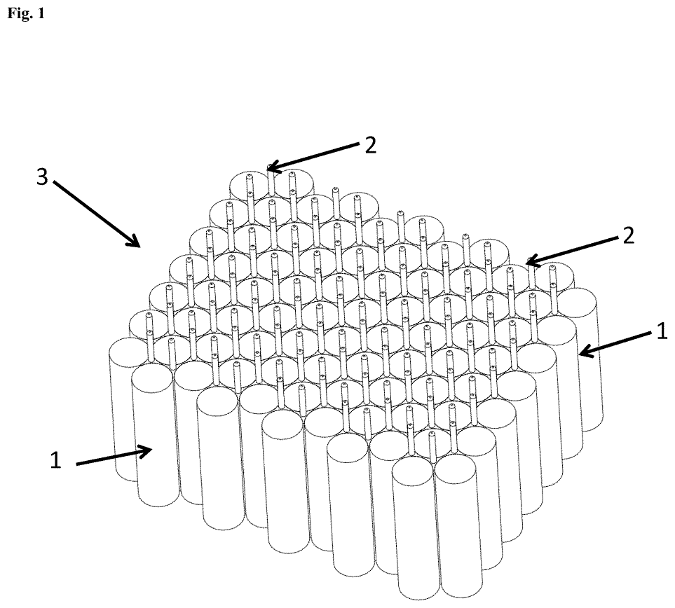

FIG. 1 shows a battery pack (3) with batteries (1) arranged in a manner analogous to the densest hexagonal packing of spheres and with insert heat pipes (2).

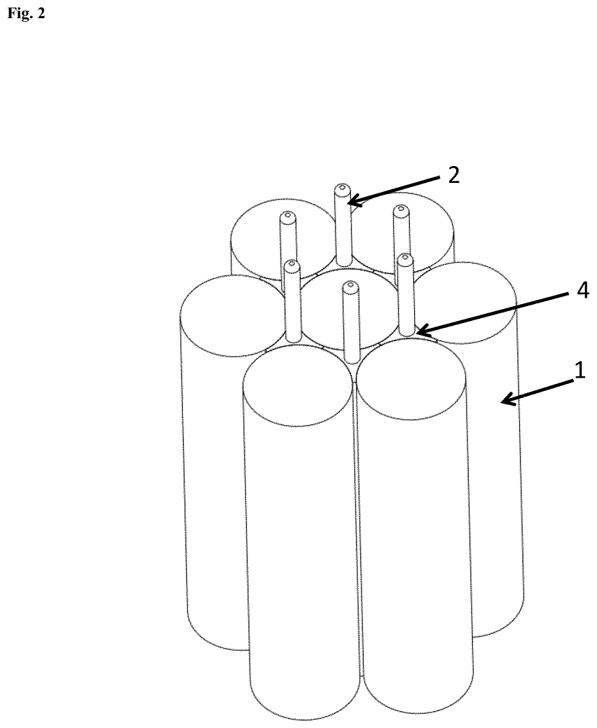

FIG. 2 shows a detail from a battery pack with batteries (1) arranged in a manner analogous to the densest hexagonal packing of spheres, with insert heat pipes (2) and heat coupling-in elements (4).

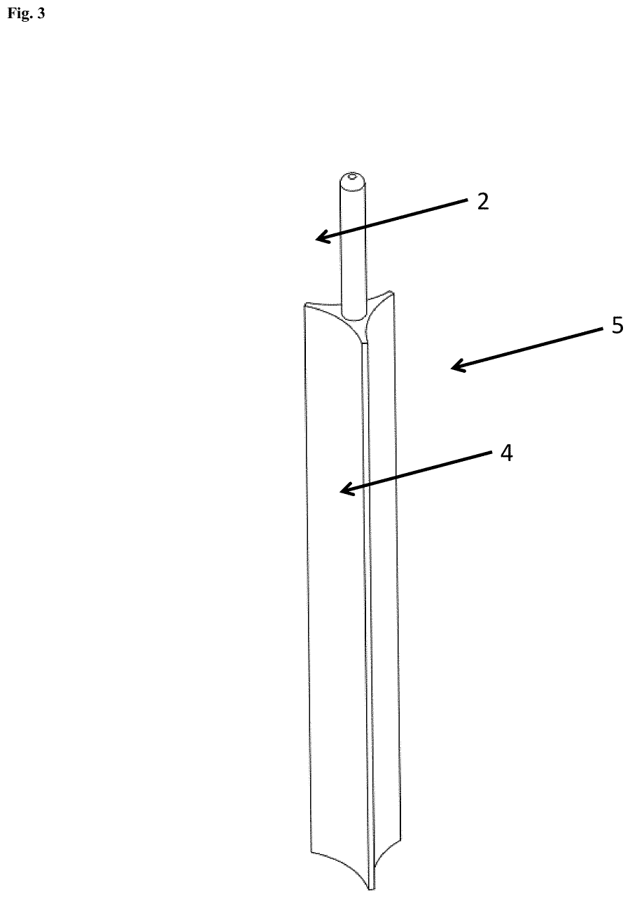

FIG. 3 shows an insert (5) with insert heat pipes (2) and heat coupling-in elements (4).

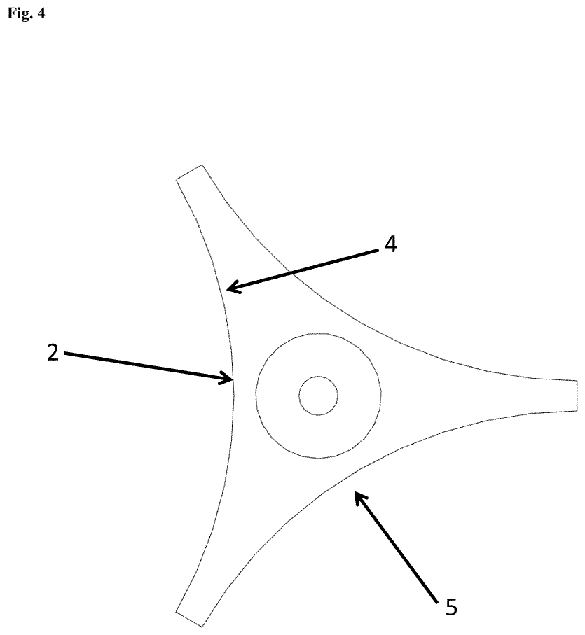

FIG. 4 shows a cross section through an insert (5) with insert heat heat pipe (2) and heat coupling-in element (4).

FIG. 5 shows a side view of multiple batteries (1) with insert heat pipes (2).

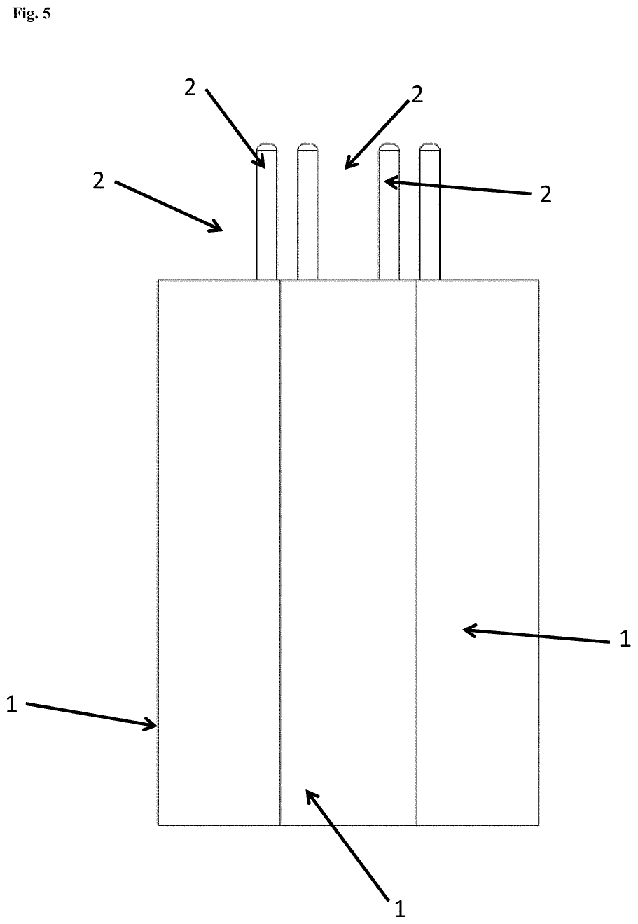

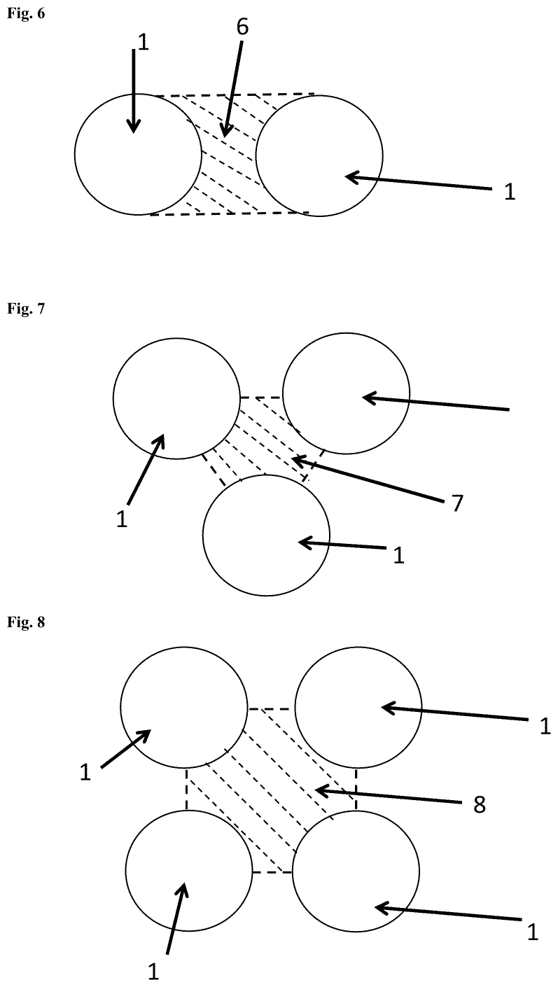

FIG. 6 shows the cross section through an arrangement of two batteries (1) in series with a neighbourhood intermediate space (6).

FIG. 7 shows the cross section through an arrangement of batteries (1) analogous to the densest hexagonal packing of spheres with a neighbourhood intermediate space (7).

FIG. 8 shows the cross section through an arrangement of batteries (1) analogous to the primitive cubic packing of spheres with a neighbourhood intermediate space (8).

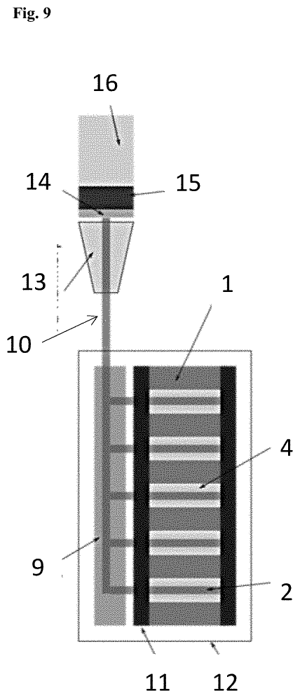

FIG. 9 shows a schematic illustration of a battery pack (3) with batteries (1), inserts (5) comprising insert heat pipes (2) and heat coupling-in elements (4), battery pack heat sink (9), battery pack heat sink heat pipe (10), cell holder (11), housing (12), hot-end heat sink (13), heat conduction layer (14), Peltier element (15) and cold-end heat sink (16).

1. A heat dissipation insert comprising an insert heat pipe and a heat coupling-in element, wherein the heat coupling-in element comprises at least 50% by weight, of a thermally conductive material having an in-plane thermal conductivity of at least 0.1 W/(m*K).

2. The heat dissipation insert of claim 1, wherein the heat coupling-in element comprises a thermally conductive thermoplastic composition having an inplane thermal conductivity of 0.1 to 30 W/(m*K), and having a volume resistivity of more than 1010 ohm*m.

3. The heat dissipation insert according to claim 1, wherein the heat coupling-in element comprises a thermally conductive thermoplastic composition having an inplane thermal conductivity of 0.5 to 50 W/(m*K).

4. The heat dissipation insert according to claim 1, wherein the heat coupling-in element comprises at least 50% by weight of a metal, in particular aluminium, copper or iron, or of a metal alloy, in particular an aluminium alloy, a copper alloy or an iron alloy.

5. The heat dissipation insert claim 1, wherein the insert heat pipe is encapsulated with the thermoplastic composition of the heat coupling-in element.

6. The heat dissipation insert of claim 1, wherein the thermoplastic composition is a composition comprising a polycarbonate.

7. A battery pack comprising the heat dissipation insert of claims 1.

8. The battery pack of claim 7, wherein the heat dissipation insert of the battery pack is connected to a battery pack heat sink.

9. The battery pack of claim 8, wherein the battery pack heat sink is connected to at least one battery pack heat sink heat pipe.

10. The battery pack according to claim 9, wherein the battery pack heat sink heat pipe is connected to an electrothermal transducer.

11. The heat dissipation insert of claim 1, wherein the insert heat pipe is connected to an electrothermal transducer.

12. The battery pack of claim 10, wherein the electrothermal transducer is a Peltier element or a thermal element.

13. The battery pack of claim 12, wherein the electrothermal transducer is a Peltier element that has a hot-end heat sink.

14. An electric car comprising a heat dissipation insert of claim 1.

15-16. (canceled)

17. The heat dissipation insert of claim 11, wherein the electrothermal transducer is a Peltier element or a thermal element.

18. The heat dissipation insert of claim 17, wherein the electrothermal transducer is a Peltier element that has a hot-end heat sink.

19. An electric car comprising a battery pack of claim 7.
